(19) United States
(12) Patent Application Publication
(10) Pub. No.: US 2003/0160930 A1
(43) Pub. Date: Aug. 28, 2003

(54) Method for forming spacers of micro-displays

(76) Inventors: Ling-Yuan Tseng, Shin Juang City (TW); Shang Wen Peng, Hsin Chu (TW); Kuo Yen Peng, Chu Bei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/082,321

(22) Filed: Feb. 26, 2002

(51) Int. Cl. G02F 1/1339

(52) U.S. Cl. 349/153

(57) ABSTRACT

A method for forming spacers in micro-displays to eliminate dark or white spots is disclosed. The method includes the steps of (1) providing a substrate for each of red, green and blue micro-displays with metallic reflective pads formed on the substrate, the pads being spaced from each other by non-reflective areas; (2) forming a coating of a transparent, non-conductive material on the substrate and over the reflective pads; (3) providing a mask associated with each substrate, each mask having a number of shielded zones that are not corresponding in location to each other; and (4) performing a lithographic operation on the transparent, non-conductive coating of each substrate of step (2) by using the associated mask of step (3) whereby portions of the transparent, non-conductive material that are corresponding to the shielded zones of the mask are left on the substrate, functioning as the spacers. The spacers of the substrates are thus not corresponding to each other in location whereby dark or white spots caused by superposition of images of the spacers of the micro-displays are effectively eliminated.

### FIELD OF THE INVENTION

The present invention generally relates to a micro-display and in particular to a method for forming spacer posts between a substrate and an ITO layer of the micro-display.

### BACKGROUND OF THE INVENTION

Image displaying devices, such as liquid crystal projector and computer monitors, that employ micro-display units are getting prevailing recently. Such image displaying devices comprise an optic engine that comprises three micro-display units, respectively associated with red, green and blue colors. Light emitted from the three micro-display units are then combined for forming color images.

FIG. 6 of the attached drawings shows a schematic structure of a conventional reflective micro-display. The micro-display comprises a substrate A on which reflective pads/layers A5 are formed and a glue frame A1 formed at perimeter of the substrate A encompassing all the reflective pads A5. An ITO glass plate A4 is attached to the glue frame A1 for forming a sealed unit A2 which is referred to as cell. The ITO glass plate A4 is spaced from the substrate A a predetermined distance H which is referred to as the cell gap in the art, for containing a liquid crystal material between the substrate A and the ITO glass plate A4. To maintain the cell gap, rigid beads A3, often referred to as spacers, are contained in the glue frame A1 for soundly supporting the ITO glass plate A4.

Adding rigid beads A3 in the plastic frame A1 for maintaining the cell gap is effective in micro-displays of low resolution and small cell A2 size. However, it is not very effective in maintaining the cell gap in micro-displays requiring high resolution and having large cell A2 size.

FIG. 7 of the attached drawings shows another conventional method for maintaining the cell gap wherein spacers A3 are distributed over the whole area of the micro-display. However, since the spacers are randomly distributed inside the micro-display, it is very likely that a dark spot on white background or a white spot on dark background caused by superposition of the images of the spacers in the red, green and blue micro-displays may become visibly perceptible, leading to flaws of image so formed.

It is thus desirable to have a method for overcoming the above-discussed problems.

### SUMMARY OF THE INVENTION

Accordingly, an object of the present invention is to provide a method for forming spacers to maintain a uniform cell gap throughout the whole area of a micro-display.

Another object of the present invention is to provide a method for making micro-displays of red, green and blue colors with controlled positioning of spacers in red green and blue micro-displays thus no superimposition of spacers exist in the same position when light from red green and blue micro-display are combined. The dark spot or white spot problem can eventually removed.

Another object of the present invention is to provide a method for forming spacers of a micro-display with reduced costs of manufacturing.

To achieve the above objects, in accordance with the present invention, there is provided a method for forming spacers in micro-displays to eliminate dark or white spots, comprising the following steps: (1) providing a substrate for each of red, green and blue micro-displays with metallic reflective pads formed on the substrate, the pads being spaced from each other by non-reflective areas; (2) forming a coating of a transparent, non-conductive material on the substrate and over the reflective pads; (3) providing a mask associated with each substrate, each mask having a number of shielded zones that are not corresponding in location to each other; and (4) performing a lithographic operation on the transparent, non-conductive coating of each substrate of step (2) by using the associated mask of step (3) whereby portions of the transparent, non-conductive material that are corresponding to the shielded zones of the mask are left on the substrate, functioning as the spacers. The spacers of the substrates are thus not corresponding to each other in location whereby dark or white spots caused by superposition of images of the spacers of the micro-displays are effectively eliminated.

### BRIEF DESCRIPTION OF THE DRAWINGS

The present invention will be apparent to those skilled in the art by reading the following description of the best mode thereof, with reference to the attached drawings, in which:

FIG. 1 is a flow chart of a method for forming spacers of a micro-display in accordance with the present invention;

FIG. 2 is a cross-sectional view showing formation of a layer of transparent non-conductive material on the metallic reflective pads on a substrate of a micro-display;

FIG. 3 is a plan view showing the alternate arrangement of spacer locations in masks for red, green and blue micro-displays;

FIG. 4 is a cross-sectional view showing the spacers formed between pixels of the micro-display in accordance with the present invention;

FIG. 5 is a plan view showing the alternate arrangement of the spacers in the red, green and blue micro-displays in accordance with the present invention;

FIG. 6 is a cross-sectional view of a conventional micro-display; and

FIG. 7 is a schematic cross-sectional view of another conventional micro-display.

### DETAILED DESCRIPTION OF BEST MODE FOR CARRYING OUT THE PRESENT INVENTION

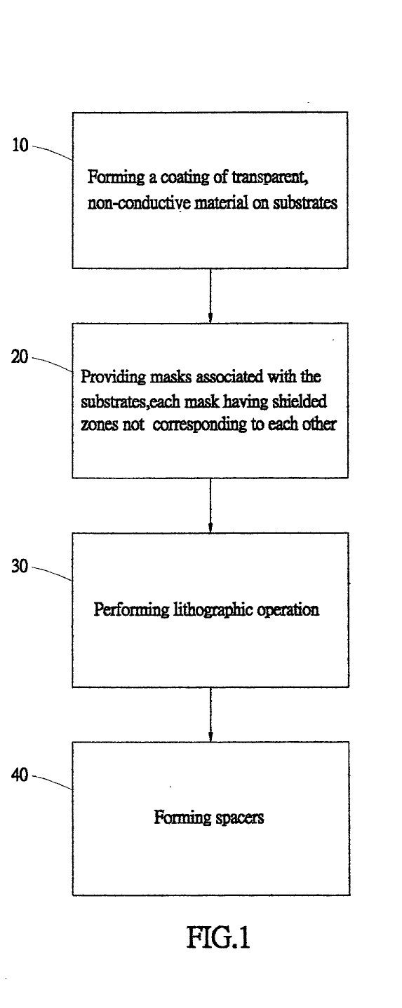

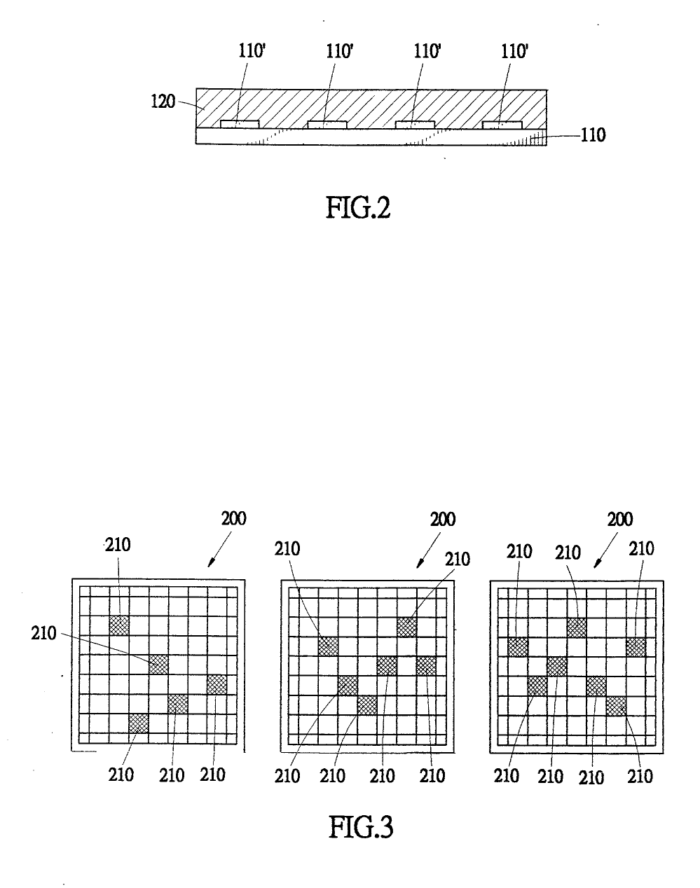

With reference to the drawings and in particular to FIGS. 1-3, a method for forming spacers in a micro-display in accordance with the present invention comprises the following steps:

A substrate 110 of a micro-display 100 (FIG. 5) is provided. The micro-display 100 comprises metallic reflective pads/layers 110′ formed on the substrate 110 and spaced from each other. The reflective pads 110′ correspond to pixels of the micro-display 100 comprised of the substrate 110 and are spaced by non-pixel area X (FIG. 5). The first step, step 10, of the method in accordance with the present invention is to form a coating of transparent, non-conductive material 120 on the substrate 110 and over the reflective pads 110′ (or the pixels). The transparent, non-conductive material 120 is selected from SiOₓ, SiNₓ, etc., such as SiO₂ and SiN₂.

The next step, step 20, is to select the locations of the spacers on masks. A mask 200 is provided for each of the red, green and blue micro-displays 100. The masks 200 are formed so as to shield the locations 210 where the spacers are to be formed. The locations 210 on the three masks 200 are selected to be not corresponding to each other and are corresponding to the non-pixel area X between the pixels of the micro-displays.

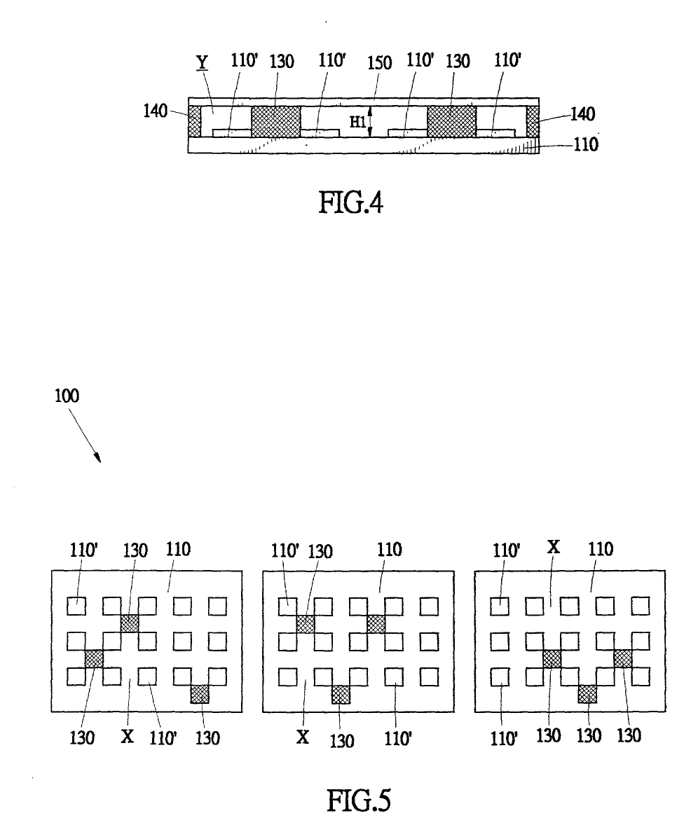

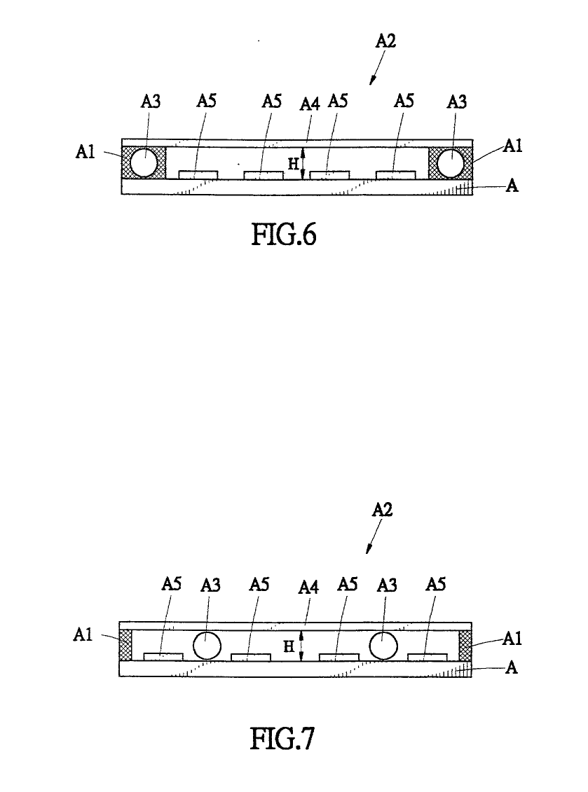

Thereafter, step 30, a lithographic operation or other suitable etching operation, is performed on the transparent, non-conductive coating 120 of step 10 by using the masks 200 of step 20. In step 40, as a result of the lithographic operation, portions of the transparent, non-conductive coating 120 that are shielded by the selected locations 210 of the masks 200 are left, forming post-like spacers 130 (FIGS. 4 and 5). Due to the careful selection of the locations 210 of the mask 200, the spacer posts 130 so formed on the red, green and blue color micro-displays 100 are not corresponding to each other in locations whereby dark or white spots caused by superposition of the images of the spacers of micro-displays are effectively eliminated.

Also referring to FIGS. 4 and 5, as a result of the method of the present invention, the spacers 130 that are formed on the red, green and blue micro-displays are located in the non-pixel area X and are not corresponding to each other. Although an example is shown in FIG. 5, it is apparent to those having ordinary skills to arrange the spacers 130 in different manners. The arrangement of the spacers 130 is in general based on the pixel size and the pixel pitch. Taking XGA (having a resolution of 1024×768) as an example, in a typical 15×15 μm² area of a micro-display, there can be 10-500 spacers 130 arranged/formed inside the micro-display.

Once the spacers 130 are formed, a glue frame 140 is formed around the substrate 110. An ITO glass plate 150 is placed on the glue frame 140 and supported by the spacers 130. An interior space Y is thus formed between the substrate 110 and the ITO glass plate 150 and a liquid crystal is filled into the interior space Y. The manufacturing of the micro-display unit 100 is thus completed.

An example of the liquid crystal material that is filled between the substrate 110 and the ITO glass plate 150 is vertical alignment liquid crystal material which helps eliminating the dark or white spots.

To this point, it is apparent that the method of the present invention offers the following advantages:

(1) First of all, the cell gap can be effectively maintained throughout the whole micro-display. By means of distribution of the spacers 130 made of SiO₂ throughout the whole micro-display at carefully selected locations, the cell gap H1 between the substrate 110 and the ITO glass plate 150 can be kept substantially uniform throughout the whole micro-display.

(2) The dark spots or white spots can be eliminated by careful arrangement of the locations of the spacers in the red, green and blue micro-displays. The selection of the locations of the spacers prevents the images of the spacers from superposition with each other and thus effectively eliminating the dark spot problem.

(3) Manufacturing costs of the micro-displays are reduced. Using lithographic operation with the masks 200 to form the spacers 130 simplifies the manufacturing process and thus reducing the costs. Furthermore, this method can be adopted in micro-displays of any resolution.

Although the best mode for carrying out the present invention has been described with reference to the drawings for illustrating the present invention, it is apparent to those skilled in the art that a variety of modifications and changes may be made without departing from the scope of the present invention which is intended to be defined by the appended claims.

What is claimed is:

1. A method for forming spacers of a micro-display comprising the following steps:
(1) providing a substrate on which reflective pads are formed, the pads being spaced from each other by non-reflective areas;
(2) forming a coating of transparent, non-conductive material on the substrate and over the reflective pads;
(3) providing a mask comprising a number of shielded zones corresponding to the non-reflective areas; and
(4) performing a lithographic operation on the transparent, non-conductive coating of step (2) by using the mask of step (3) whereby portions of the transparent, non-conductive material that are corresponding to the shielded zones of the mask are left on the substrate, functioning as spacers.

2. The method as claimed in claim 1, wherein the transparent, non-conductive material comprises SiOₓ.

3. The method as claimed in claim 2, wherein the SiOₓ comprises SiO₂.

4. The method as claimed in claim 1, wherein the transparent, non-conductive material comprises SiNₓ.

5. The method as claimed in claim 4, wherein the SiNₓ comprises SiN₂.

6. A method for forming spacers of at least two micro-displays of a displaying device comprising the following steps:
(1) providing a substrate for each of the at least two micro-displays with reflective pads formed on the substrate, the pads being spaced from each other by non-reflective areas;
(2) forming a coating of transparent, non-conductive material on the substrate and over the reflective pads;
(3) providing a mask associated with each substrate, each mask comprising a number of shielded zones that are not corresponding in location to each other; and
(4) performing a lithographic operation on the transparent, non-conductive coating of each substrate of step (2) by using the associated mask of step (3) whereby portions of the transparent, non-conductive material that are corresponding to the shielded zones of the mask are left on the substrate, functioning as spacers, the spacers of the substrates being not corresponding in location to each other.

7. The method as claimed in claim 6, wherein the transparent, non-conductive material comprises SiOₓ.

8. The method as claimed in claim 7, wherein the SiOₓ comprises SiO₂.

9. The method as claimed in claim 6, wherein the transparent, non-conductive material comprises SiNₓ.

10. The method as claimed in claim 9, wherein the SiNₓ comprises SiN₂.

11. The method as claimed in claim 6, wherein the shielded zones of each mask are arranged to be corresponding to some of the non-reflective areas.
